(19) United States
(12) Patent Application Publication
(10) Pub. No.: US 2022/0303682 A1
(43) Pub. Date: Sep. 22, 2022

(54) METHOD, UE AND NETWORK NODE FOR HANDLING SYNCHRONIZATION OF SOUND

(71) Applicant: Telefonaktiebolaget LM Ericsson (publ), Stockholm (SE)

(72) Inventor: Fredrik BONDE, Torslanda (SE)

(73) Assignee: Telefonaktiebolaget LM Ericsson (publ), Stockholm (SE)

(21) Appl. No.: 17/618,255

(22) PCT Filed: Jun. 11, 2019
(86) PCT No.: PCT/SE2019/050545

§ 371 Date: Dec. 10, 2021

(51) Int. Cl. H04R 3/12; H04R 5/04; H04R 5/033; H04R 27/00

(52) U.S. Cl. CPC H04R 3/12; H04R 5/04; H04R 5/033; H04R 27/00

(57) ABSTRACT

The embodiments herein relate to a method performed by a UE (108) for handling synchronization of sound. The UE (108) determines that speaker sound is currently outputted or will be outputted from at least one main speaker (100) located at a distance from the UE (108). The UE (108) determines a time delay between an output time for output of speaker sound from the main speaker (100) and an arrival time for arrival of the speaker sound at the UE (108). The time delay is individually determined for the UE (108). The UE (108) outputs synchronized sound comprising at least a part of the speaker sound with the time delay. The synchronized sound is outputted by at least one wearable UE speaker (110) comprised in the UE (108) in synchrony with the speaker sound outputted by the main speaker (100) with respect to time delay and pace.

### TECHNICAL FIELD

Embodiments herein relate generally to a User Equipment (UE), a method performed by the UE, a network node and a method performed by the network node. More particularly the embodiments herein relate to handling synchronization of sound.

### BACKGROUND

The sound experience when being at a concert, a movie, a sports event etc. is important for the persons participating in the event. However, at large arenas, venues, conference rooms, theatres or other locations, the sound experience may depend on for example where the listener is located compared to where the sound is generated. For example, the sound experience may be much better when having a seat close to the scene compared to having a seat in the back row. This may be due to the time delay for the sound when it propagates from the speakers at the scene to the listener at the back row.

At events taking place at large arenas, several loudspeakers may be placed at different locations. A loudspeaker is defined by the Merriam-Webster dictionary at https://www.merriam-webster.com/dictionary/loudspeaker as “a device that changes electrical signals into sounds loud enough to be heard at a distance”. The term speaker will be used herein for the sake of simplicity when referring to a loudspeaker. Placing speakers at the scene will provide a good sound experience for the listeners having front seats. However, the listeners at the back seats will not have the same sound experience due to time delay of the sound because of the distance between them and the main speakers. To improve the sound experience for the listener being located at some distance from the scene and the main speakers, speakers referred to as ancillary speakers or delay speakers may be used. Ancillary speakers may be described as additional speakers, additional to the main speakers, used to properly cover the audience and that applies a time delay for improving the sound experience. The ancillary speakers need to be time aligned with the main speakers so that the sound outputted from the ancillary speakers arrives at the audience in time with the sound from the main speakers.

Signals from the control system which controls both the main speaker at the scene and the ancillary speakers will reach all listeners simultaneously. On the other hand, sound travelling from the main speaker to the audience through the air will travel at the speed of sounds, which is much slower compared to the signals from the control system, resulting in a time gap between the sound sources. This time gap will be perceived as a bad sound experience by the listener, e.g. in the form of an echo or other time delay, sound disturbance or sound irregularity.

Ancillary speakers provide substantially the same sound experience for all listeners in its surroundings. However, different listeners may have different requirements and desires when it comes to what they think are an optimal sound experience for them.

Therefore, there is a need to at least mitigate or solve this issue.

### SUMMARY

An objective of embodiments herein is therefore to obviate at least one of the above disadvantages and to provide improved handling of sound synchronization.

According to a first aspect, the object is achieved by a method performed by a UE for handling synchronization of sound. The UE determines that speaker sound is currently outputted or will be outputted from at least one main speaker located at a distance from the UE. The UE determines a time delay between an output time for output of speaker sound from the at least one main speaker and an arrival time for arrival of the speaker sound at the UE. The time delay is individually determined for the UE. The UE outputs synchronized sound comprising at least a part of the speaker sound with the time delay. The synchronized sound is outputted by at least one wearable UE speaker comprised in the UE in synchrony with the speaker sound outputted by the at least one main speaker with respect to time delay and pace.

According to a second aspect, the object is achieved by a method performed by a network node for handling synchronization of sound. The network node determines that speaker sound is currently outputted or will be outputted from at least one main speaker located at a distance from a UE. The network node determines a time delay between an output time for output of speaker sound from the at least one main speaker and an arrival time for arrival of the speaker sound at the UE. The time delay is individually determined for the UE. The network node provides information indicating the determined time delay to the UE.

According to a third aspect, the object is achieved by a UE adapted for handling synchronization of sound. The UE is adapted to determine that speaker sound is currently outputted or will be outputted from at least one main speaker located at a distance from the UE. The UE is adapted to determine a time delay between an output time for output of speaker sound from the at least one main speaker and an arrival time for arrival of the speaker sound at the UE. The time delay is individually determined for the UE. The UE is adapted to output synchronized sound comprising at least a part of the speaker sound with the time delay. The synchronized sound is outputted by at least one wearable UE speaker comprised in the UE in synchrony with the speaker sound outputted by the at least one main speaker with respect to time delay and pace.

According to a fourth aspect, the object is achieved by a network node adapted for handling synchronization of sound. The network node is adapted to determine that speaker sound is currently outputted or will be outputted from at least one main speaker located at a distance from a UE. The network node is adapted to determine a time delay between an output time for output of speaker sound from the at least one main speaker and an arrival time for arrival of the speaker sound at the UE. The time delay is individually determined for the UE. The network node is adapted to provide information indicating the determined time delay to the UE.

Since the time delay is determined individually for each UE and it takes into account the mobility of the UE, the handling of the sound synchronization is improved, i.e. the user associated with the UE perceives the synchronized sound without time delay even when he moves around.

Embodiments herein afford many advantages, of which a non-exhaustive list of examples follows:

An advantage of the embodiments herein is that the sound outputted in the UE speaker is improved with respect to the sound outputted from the at least one main speaker.

Another advantage of the embodiments herein is that time gap in the sound outputted in the wearable UE speaker is reduced or removed due to the use of the time delay.

A further advantage of the embodiments herein is that it provides a flexible sound system in that each UE has an individual time delay especially determined for it, providing a unique and improved sound experience for the user of the UE.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1a is a schematic illustration of a sound system.

FIG. 1b is a schematic illustration of a sound system.

FIG. 2 is a signaling diagram illustrating a method.

FIG. 3 is a flow chart illustrating a method performed by the UE.

FIG. 4 is a schematic block diagram illustrating an UE.

FIG. 5 is a flow chart illustrating a method performed by the network node.

FIG. 6 is a schematic block diagram illustrating a network node.

The drawings are not necessarily to scale and the dimensions of certain features may have been exaggerated for the sake of clarity. Emphasis is instead placed upon illustrating the principle of the embodiments herein.

### DETAILED DESCRIPTION

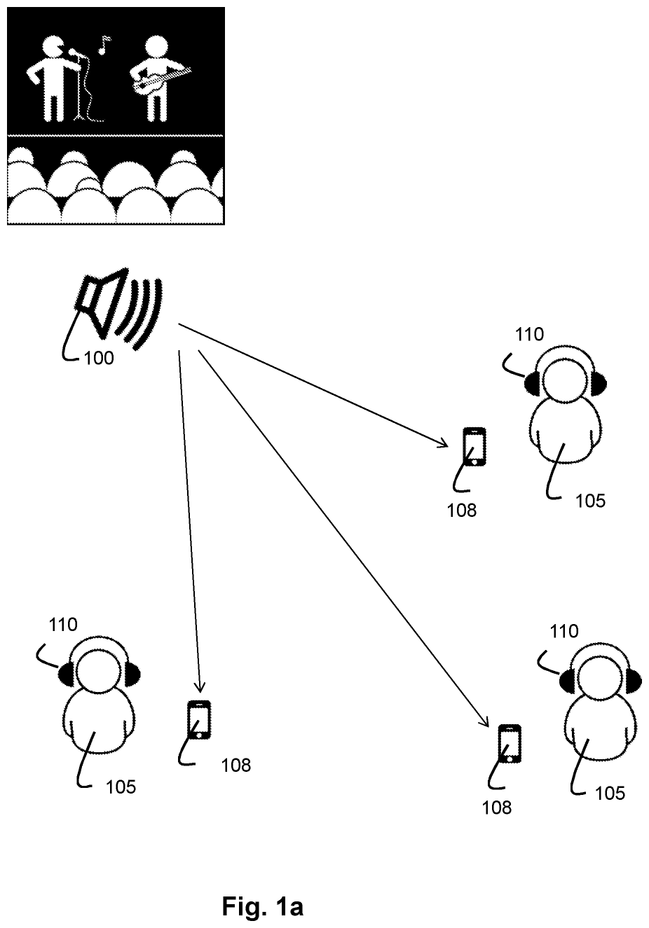

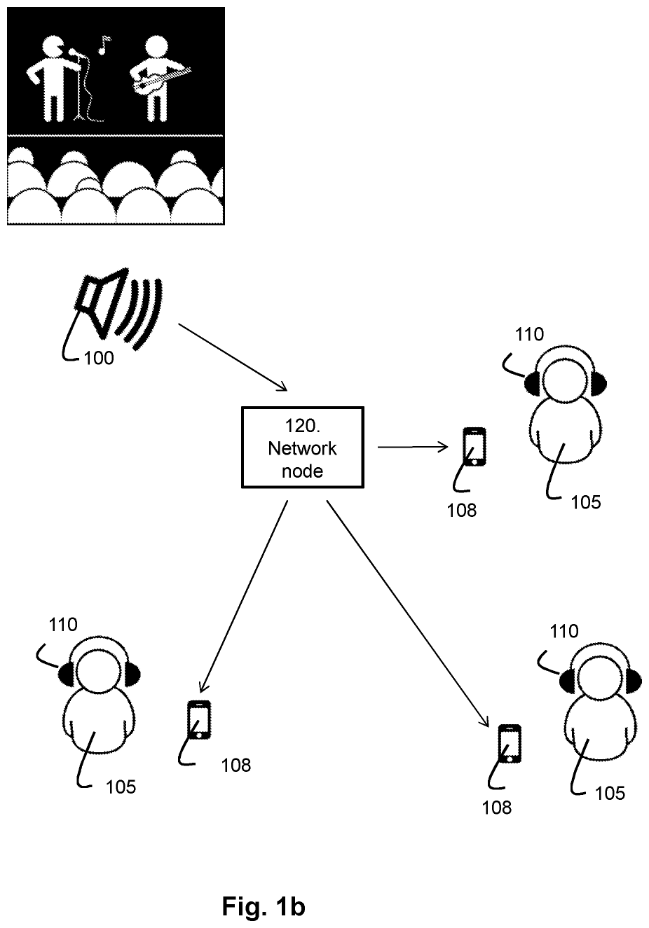

FIG. 1a is a schematic illustration of a sound system. The sound system is located at a location, which is exemplified with a concert location in FIG. 1a. The sound system comprises at least one main speaker 100 located in proximity to the location from where the sound is originally produced, e.g. in proximity to the scene where the band is located and plays its music. There may be one, two or more main speakers 100. In other words, there may be one or multiple main speakers 100. One main speaker 100 is exemplified in FIG. 1a for the sake of simplicity.

When there are two or more main speakers 100, i.e. there is a plurality of main speakers 100, then there may be a distance between them even though they are located in proximity to the location from where the sound is originally produced. For example, one main speaker 100 may be located at a left corner of the scene, two main speakers 100 may be located at the center of the scene and one main speaker 100 may be located at the right corner of the scene. When there is a plurality of main speakers 100, then they may be adapted to output at least substantially the same sound, or they may be adapted to output at least substantially the same sound but with different amount of base, tremble, volume etc.

The at least one main speaker 100 may be a non-delay speaker. A non-delay speaker maybe described as a speaker that is adapted to output sound without delay from where it is originally produced, created or played. The at least one main speaker 100 is adapted to output sound. The at least one main speaker 100 may also be referred to as a first speaker, a primary speaker, a central speaker, a master speaker, etc. The term delay may also be referred to as postponement, lag, waiting period etc.

At least one user 105 is located at the location, e.g. they are listeners or participants at the concert. FIG. 1a shows an example with three users 105, but any n number of users 105 is applicable, where n is a positive integer.

At least one user 105 is associated with at least one UE 108. One user 105 may be associated with one UE 108, or one user 105 may be associated or two or more UEs 108, or two or more users 105 may be associated with the same UE 108. The UE 108 may be a device by which a subscriber may access services offered by an operator's network and services outside operator's network to which the operator's radio access network and core network provide access, e.g. access to the Internet. The UE 108 may be any device, mobile or stationary, enabled to communicate in the communications network, for instance but not limited to e.g. user equipment, mobile phone, smart phone, sensors, meters, vehicles, household appliances, medical appliances, media players, cameras, Machine to Machine (M2M) device, Device to Device (D2D) device, Internet of Things (IoT) device, terminal device, communication device or any type of consumer electronic, for instance but not limited to television, radio, lighting arrangements, tablet computer, laptop or Personal Computer (PC). The UE 108 may be portable, pocket storable, hand held, computer comprised, or vehicle mounted devices, enabled to communicate voice and/or data, via the radio access network, with another entity, such as another UE or a server.

The UE 108 may be associated with at least one UE speaker 110. The UE speaker 110 may be a separate speaker, it may be a speaker at least partly integrated in the UE 108, i.e. it may be at least partly co-located with the UE 108. The UE speaker 110 may be adapted to be connected to the UE 108, e.g. via a wired or wireless connection, e.g. Bluetooth, WiFi, WiFi Direct, ZigBee, Near Field Communication (NFC) etc. The UE speaker 110 may be referred to as headphones, earphones, portable UE speaker 110 or a wearable UE speaker etc. The UE speaker 110 may also be referred to as an ancillary speaker, a second speaker, a secondary speaker, a supplementary speaker, an auxiliary speaker etc. The UE speaker 110 is adapted to output sound to be perceived by at least one user 105 associated with the UE 108. The UE speaker 110 may be adapted to communicate with at least one UE 108. The UE speaker 110 may be adapted to be controlled by the UE 108 and/or a network node 120. One UE 108 may be adapted to be associated with one UE speaker 110, or to two or more UE speakers 110. For example, two users 105 may each have their respective UE speakers 110, and the two UE speakers 110 are associated with only one UE 105. In another example, one user 105 has one UE speaker 110 which is associated with one UE 105. The UE speaker 110 may comprise a right ear part and a left ear part, where the respective part is adapted to be placed on, inside or in proximity of the user's right and left ears. The user 105 may for example have the associated UE 108 in its hand, in its pocket, in its bag etc.

There may be a distance between the at least one main speaker 100 and the user 105 and its associated UE 108. The user 105 associated with the UE 108 may move when being at the location, e.g. the concert, such that the distance between the at least one main speaker 100 and the UE 108 may vary during the output of the speaker sound, e.g. he may walk around, ride a scooter etc.

FIG. 1b shows an example of the sound system comprising at least some of the entities in FIG. 1a. In addition, the sound system exemplified in FIG. 1b comprises one or multiple network nodes 120. The network node 120 may be explained as being located between the at least one main speaker 100 and the UE 108. In other words, the network node 120 may be adapted to communicate with both the at least one main speaker 100 and the UE 108, for example by providing sound outputted from the main speaker 103 to the UE 108. The network node 120 may provide the sound outputted from the at least one main speaker 100 by e.g. broadcasting. The network node 120 may be any suitable network node, it may be an access network node and/or a core network node. Examples of an access network node may be a Node B (NB), evolved NB (eNB), gNB, Master evolved NB (MeNB), Radio Network Controller (RNC) etc. Examples of a core network node may be a Mobility Management Entity (MME), a gateway such as a Packet Data Network Gateway (PDN GW, PGW), a Serving Gateway (SGW), an Access and Mobility Management Function (AMF), a Session Management Function (SMF), User Plane Function (UPF) etc. The sound outputted from the at least one main speaker 100 may be provided directly from the at least one main speaker 100 to the UE108 as exemplified in FIG. 1a, or it may be provided from the at least one main speaker 100, via the network node 120 before reaching by the UE 108 as exemplified in FIG. 1b.

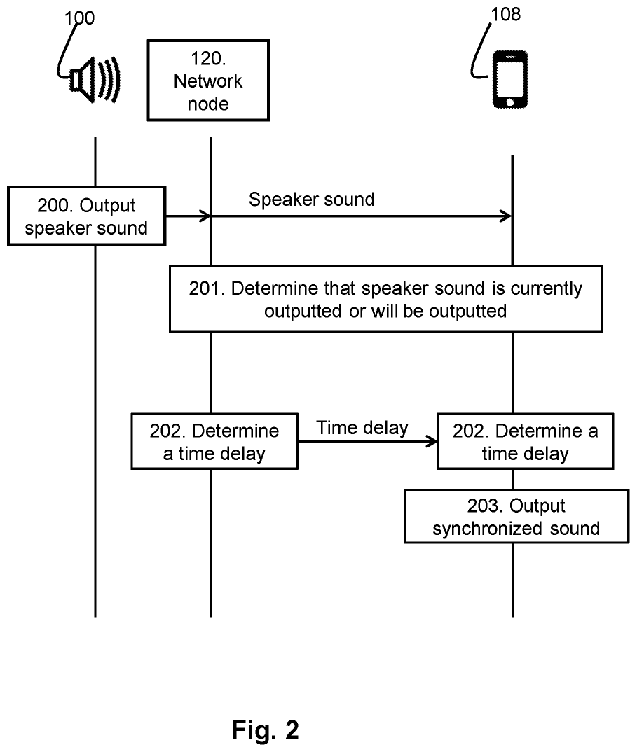

A method for handling synchronization of sound, according to some embodiments will now be described with reference to the signaling diagram depicted in FIG. 2 with reference to the block diagrams in FIG. 1a and FIG. 1b. The method exemplified in FIG. 2 comprises at least one of the following steps, which steps may as well be carried out in another suitable order than described below:

Step 200

The at least one main speaker 100 outputs speaker sound. The speaker sound outputted from the at least one main speaker 100 may be obtained by the UE 108, e.g. it may be obtained by the UE speaker 110 associated with the UE 108. This may also be referred to as the UE 108 may detect or receive the speaker sound outputted by the at least one main speaker 100. The speaker sound outputted from the at least one main speaker 100 may be obtained by the network node 120, and then further provided by the network node 120 to the UE 108. This may also be referred to as the UE 108 may detect or receive the speaker sound outputted by the at least one main speaker 100 via the network node 120.

Step 200 may be performed before step 201, or it may be performed between steps 202 and 203.

Step 201

The UE 108 determines that speaker sound is currently outputted by the at least one main speaker 100 or that speaker sound will be outputted by the at least one main speaker 100. Currently outputted speaker sound may be referred to as speaker sound outputted by the at least one main speaker 100 at this time, at present, now. That speaker sound will be outputted may be described as speaker sound that will be outputted in the future, at a later time compared to when the determining is done.

The UE 108 may determine that speaker sound will be outputted by the at least one main speaker 100 by receiving, from the user 105, information indicating the coming output of sound, e.g. when the user 105 activates a button comprised in the UE 108, that the user 105 activates an application comprised in the UE 105 and associated with output of the speaker sound etc. The UE 108 may determine that speaker sound will be outputted by the at least one main speaker 100 by receiving information indicating the coming sound output from the at least one main speaker 100, from the network node 120 or from a communications node (not shown in FIG. 2a) associated with e.g. the organizer of the concert, for example in the form of a broadcast message broadcasted to all UEs 108 within a certain geographical area, to all UEs 108 which has “checked in” at the concert, to all UEs 108 which have a valid and activated entry pass to the concert etc. The communications node associated with the organizer of e.g. the concert may be for example a main UE, a main computer, it may be comprised in the at least one main speaker 100 etc. The communications node is not located within any access network or core network.

This step 201 may also be performed by the network node 120, and then the UE 108 determines that the speaker is currently or will output speaker sound by receiving information indicating this from the network node 120. The network node 120 may determine this in the same way as described above for the UE 108.

Step 202

The UE 108 determines a time delay between an output time for output of speaker sound from the at least one main speaker 100 and an arrival time for arrival of the speaker sound at the UE 108. The determining in step 201 may be seen as a trigger for determining the time delay. The time delay is individually determined for the UE 108. For example, when there is a plurality of UEs 108 which is located in the proximity of the at least one main speaker 100 and which receive the outputted speaker sound, then each UE 108 determines its time delay. Thus, the time delay may be different for each UE 108 which means that the time delay is optimized for each UE 108 such that the user of the UE 108 gets the best possible sound experience.

The UE 108 may determine the time delay based on the position of the at least one main speaker 100 and the UE's position, or it may determine the time delay e.g. by detecting or receiving the speaker sound with a microphone associated with the UE 108, and then the user 105 may manually determine the time delay by moving a time delay handle comprised in the UE 108, or the UE 108 may automatically determine the time delay. The position of the UE 108 may be obtained e.g. via positioning unit comprised in the UE 108. The position of the at least one main speaker 100 may be obtained via the positioning unit comprised in the UE 108. The positioning unit may be based on any suitable Global Navigation Satellite Systems (GNSS) such as e.g. Global Positioning System (GPS), Globalnaya Navigatsionnaya Sputnikovaya Sistema (GLONASS), Galileo, Beidou etc.

The UE 108 may determine the time delay by receiving information indicating the time delay from the network node 120. Thus, the network node 120 may determine the time delay and provides information indicating the time delay to the UE 108.

In case there is a plurality of main speakers 100, then the UE 108 may determine a time delay for each of the main speakers 100 in the plurality. With this, the stereo effect provided by having the plurality of main speakers 100 may be recreated in the UE speaker 110.

Step 203

The UE 108 outputs synchronized sound. The synchronized sound comprises at least a part of the speaker sound with the time delay, e.g. the time delay is added to the speaker sound. The synchronized sound is outputted by at least one wearable UE speaker 110 comprised in the UE 108 in synchrony with the speaker sound outputted by the at least one main speaker 100 with respect to time delay and pace. As mentioned earlier, the wearable UE speaker 110 may be referred to as headphones, earphones, a portable UE speaker 110 etc. When the synchronized sound is outputted in synchrony with the speaker sound outputted with respect to time delay, it is consequently outputted in synchrony with respect to pace, e.g. speed of the sound.

A method for handling synchronization of sound, according to some embodiments will now be described with reference to the signaling diagram depicted in FIG. 2b with reference to the block diagram in FIG. 1 b. A difference between the method exemplified in FIG. 2a and FIG. 2b is that the network node 120 is in involved in the method exemplified in FIG. 2b. The method exemplified in FIG. 2b comprises at least one of the following steps, which steps may as well be carried out in another suitable order than described below:

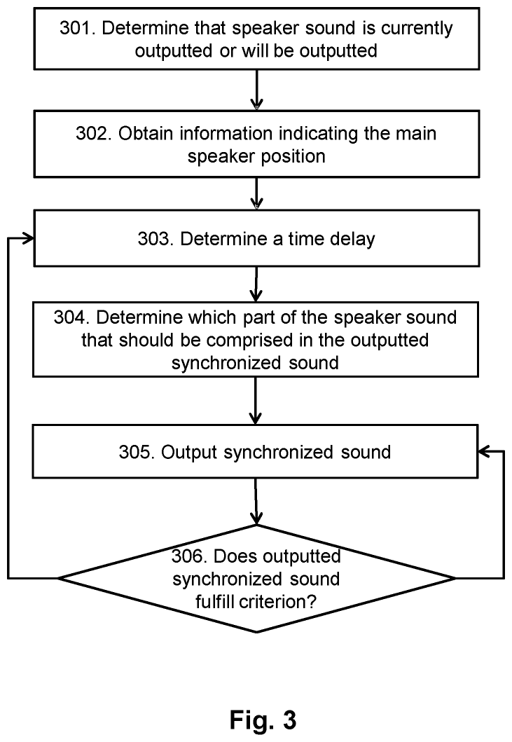

The method described above will now be described seen from the perspective of the UE 108. FIG. 3 is a flowchart describing the present method performed by the UE 108, for handling synchronization of sound. The method comprises at least one of the following steps to be performed by the UE 108, which steps may be performed in any suitable order than described below:

Step 301

This step corresponds to step 201 in FIG. 2. The UE 108 determines that speaker sound is currently outputted or will be outputted from at least one main speaker 100 located at a distance from the UE 108. This may also be described as the UE 108 determines that synchronized sound should be outputted, that it is triggered to start a method for handling synchronization of sound etc. For example, the UE 108 may determine this based on that the user 105 activates an application associated with the concerts, when the concert organizer broadcasts a message to the UEs 108 at the concert location or to UEs 108 where the user 105 has checked into the concert or has a valid and activated ticket etc. See step 201 described above for more details regarding this.

Step 302

The UE 108 may obtain information indicating a position of the at least one main speaker 100. The UE 108 may obtain this information by receiving input regarding the position from the user 105 of the UE 108, it may obtain the information from the network node 120, it may obtain the information from a communication node associated with e.g. the organizer of the concert, conference, it may obtain the information by retrieving it from a memory unit etc.

Step 303

This step corresponds to step 202 in FIG. 2. The UE 108 determines a time delay between an output time for output of speaker sound from the at least one main speaker 100 and an arrival time for arrival of the speaker sound at the UE 108. The time delay is individually determined for the UE 108. The UE 108 may determine one, two or more time delays.

The time delay may be re-determined when it is detected that the distance between the at least one main speaker 100 and the UE 108 has changed compared to when a previous time delay was determined. This may occur for example when the user 105 associated with the UE 108 moves around. In other words, the mobility of the UE 108 may be taken into account such that the sound experience perceived by the user of the UE 108 is not negatively affected or affected at all when the position of the UE 108 changes.

The time delay may be determined based on the distance between the UE 108 and the at least one main speaker 110.

The time delay may be determined by obtaining information indicating the time delay from a user 105 of the UE 108.

The determined time delay may comprise a first time delay and a second time delay.

When a plurality of main speakers 100 are currently outputting or will be outputting the speaker sound, then the time delay may be determined for each of the main speakers 100 in the plurality.

The time delay may be determined by receiving the time delay from a network node 120.

Step 304

The UE 108 may determine which parts of the speaker sound that should be comprised in the outputted synchronized sound. The speaker sound may comprise multiple parts, e.g. treble, base etc., and the UE 108 may determine that one, two or multiple of these parts should be comprised in the outputted synchronized sound. This step may comprise determining a volume of each part that should be comprised in the outputted synchronized sound. For example, the UE 108 may determine that the tremble should be comprised in the outputted synchronized sound with a double volume or double amount compared to the base.

The UE 108 may determine the parts automatically or based on input received from the user 105 of the UE 108.

Step 305

This step corresponds to step 203 in FIG. 2. The UE 108 outputs synchronized sound comprising at least a part of the speaker sound with the time delay. The synchronized sound is outputted by at least one wearable UE speaker 110 comprised in the UE 108 in synchrony with the speaker sound outputted by the at least one main speaker 100 with respect to time delay, and consequently in pace.

As mentioned above, the determined time delay may comprise a first time delay and a second time delay. The synchronized sound may be outputted with the first time delay in a left ear part of a UE speaker 110 and with the second time delay in a right ear part of the UE speaker 110. The first time delay may be the same as the second time delay, or the first time delay may be different from the second time delay. When the first time delay and the second time delay are different from each other, then the outputted synchronized sound provides a stereo effect for the user 105 of the UE 108.

The speaker sound may be outputted over air from at least one main speaker 100 via a network node 120 before being detected, received or reached by the UE 108.

The UE speaker 110 may be co-located with the UE 108 or adapted to be connected to the UE 108.

When a plurality of main speakers 100 are currently outputting or will be outputting the speaker sound, then the time delay may be determined for each of the main speakers 100 in the plurality, and the synchronized sound may comprise the speaker sound from each of the main speakers 100 and their respective time delay.

Step 306

The UE 108 may determine if the outputted synchronized sound fulfills a criterion. The criterion may for example be associated with an accuracy of the synchronized sound, e.g. the accuracy of the timing comprised in the synchronized sound.

For example, the criterion may be that the accuracy of the timing should be 98% or higher, between 80%-100%, above 90%, 100% etc.

When the criterion is not fulfilled, then the step of determining the time delay, i.e. step 303, and the step of outputting the synchronized sound, i.e. step 304, may be repeated by the UE 108 until the criterion is fulfilled.

When the criterion is fulfilled, then the UE 108 may determine that only the step of outputting the synchronized sound, i.e. step 304, should be repeated.

In some embodiments, a computer program may comprise instructions which, when executed on at least one processor, cause the at least one processor to carry out the method steps 301-306. A carrier may comprise the computer program, and the carrier is one of an electronic signal, optical signal, radio signal or computer readable storage medium.

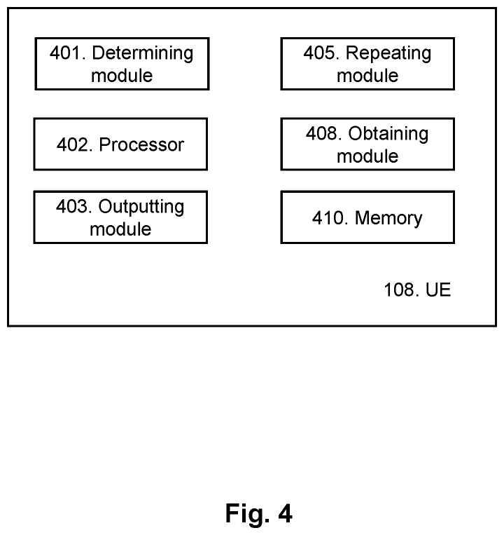

To perform the method steps shown in FIG. 3 for handling synchronization of sound the UE 108 may comprise an arrangement as shown in FIG. 4.

The UE 108 is adapted to, e.g. by means of a determining module 401, determine that speaker sound is currently outputted or will be outputted from at least one main speaker 100 located at a distance from the UE 108. The determining module 401 may also be referred to as a determining unit, a determining means, a determining circuit, means for determining etc. The determining module 401 may be a processor 402 of the UE 108 or comprised in the processor 402 of the UE 108.

The UE 108 is adapted to, e.g. by means of the determining module 401, determine a time delay between an output time for output of speaker sound from the at least one main speaker 100 and an arrival time for arrival of the speaker sound at the UE 108. The time delay is individually determined for the UE 108.

The UE 108 is adapted to, e.g. by means of an outputting module 403, output synchronized sound comprising at least a part of the speaker sound with the time delay. The synchronized sound is outputted by at least one wearable UE speaker 110 comprised in the UE 108 in synchrony with the speaker sound outputted by the at least one main speaker 100 with respect to time delay and pace. The outputting module 403 may also be referred to as an outputting unit, an outputting means, an outputting circuit, means for outputting etc. The outputting module 403 may be the processor 402 of the UE 108 or comprised in the processor 402 of the UE 108. The outputting module 403 may also be referred to as a transmitting module.

The UE 108 may be adapted to, e.g. by means of the determining module 401, re-determine the time delay when it is detected that the distance between the at least one main speaker 100 and the UE 108 has changed compared to when a previous time delay was determined.

The UE 108 may be adapted to, e.g. by means of the determining module 401, determine the time based on the distance between the UE 108 and the at least one main speaker 100.

The UE 108 may be adapted to, e.g. by means of the determining module 401, determine the time delay by obtaining information indicating the time delay from a user 105 of the UE 108.

The UE 108 may be adapted to, e.g. by means of the determining module 401, determine the time delay by receiving information indicating the time delay from a network node 120.

The UE 108 may be adapted to, e.g. by means of the determining module 401, determine if the outputted synchronized sound fulfills a criterion.

The UE 108 may be adapted to, e.g. by means of a repeating module 405, when the criterion is not fulfilled, repeat the steps of determining the time delay and outputting the synchronized sound until the criterion is fulfilled. The repeating module 405 may also be referred to as a repeating unit, a repeating means, a repeating circuit, means for repeating etc. The repeating module 405 may be a processor 402 of the UE 108 or comprised in the processor 402 of the UE 108.

The UE 108 may be adapted to, e.g. by means of a determining module 401, when the criterion is fulfilled, determine that only the step of outputting the synchronized sound should be repeated.

The UE 108 may be adapted to, e.g. by means of the determining module 401, determine which parts of the speaker sound that should be comprised in the outputted synchronized sound.

The UE 108 may be adapted to, e.g. by means of an obtaining module 408, obtain information indicating a position of the at least one main speaker 100. The obtaining module 408 may also be referred to as an obtaining unit, an obtaining means, an obtaining circuit, means for obtaining etc. The obtaining module 408 may be the processor 402 of the UE 108 or comprised in the processor 402 of the UE 108. The obtaining module 408 may be referred to as a receiving module.

The determined time delay may comprise a first time delay and a second time delay, and the UE 108 may be adapted to, e.g. by means of the outputting module 403, output the synchronized sound with the first time delay in a left ear part of a UE speaker 110 and with the second time delay in a right ear part of the UE speaker 110.

The speaker sound may be outputted over air from at least one main speaker 100 via a network node 120 before being detected by the UE 108.

The UE speaker 110 may be co-located with the UE 108 or adapted to be connected to the UE 108.

When a plurality of main speakers 100 are currently outputting or will be outputting the speaker sound, then UE 108 may be adapted to, e.g. by means of the determining module 401, determine the time delay for each of the main speakers 100 in the plurality, and the synchronized sound comprises the speaker sound from each of the main speakers 100 and their respective time delay.

The UE 108 may further comprise a memory 410 comprising one or more memory units. The memory 410 is arranged to be used to store data, received data streams, power level measurements, time delay, synchronized sound, distances, position, speaker sound, criterion information, threshold values, time periods, configurations, schedulings, and applications to perform the methods herein when being executed in the UE 108.

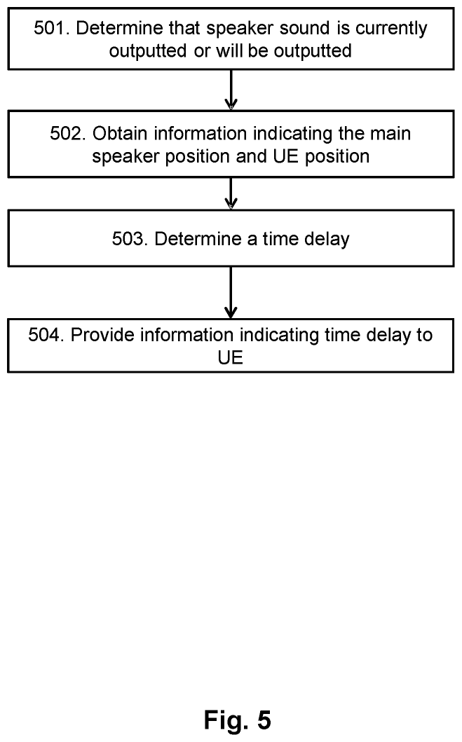

The method described above will now be described seen from the perspective of the network node 120. FIG. 5 is a flowchart describing the present method performed by the network node 120 for handling synchronization of sound. The network node 120 may be an access network node or a core network node. The method illustrated in FIG. 5 comprises at least one of the following steps to be performed by the network node 120, which steps may be performed in any suitable order than described below:

Step 501

This step corresponds to step 201 in FIG. 2. The network node 120 determines that speaker sound is currently outputted or will be outputted from at least one main speaker 100 located at a distance from a UE 108.

Step 502

This step corresponds to step 202 in FIG. 2. The network node 120 may obtain information indicating a speaker position of the at least one main speaker 100 and a UE position of the UE 108.

Step 503

This step corresponds to step 202 in FIG. 2. The network node 120 determines a time delay between an output time for output of speaker sound from the at least one main speaker 100 and an arrival time for arrival of the speaker sound at the UE 108. The time delay is individually determined for the UE 108.

The time delay may be re-determined when it is detected that the distance between the at least one main speaker 100 and the UE 108 has changed compared to when a previous time delay was determined.

The time delay may be determined based on the distance between the UE 108 and the at least one main speaker 100.

The determined time delay may comprise a first time delay and a second time delay.

When a plurality of main speakers 100 are currently outputting or will be outputting the speaker sound, then the time delay is determined for each of the main speakers 100 in the plurality.

Step 504

This step corresponds to step 202 in FIG. 2. The network node 120 provides information indicating the determined time delay to the UE 108.

The network node 120 may convey speaker sound outputted over air from at least one main speaker 100 to the UE 108.

In some embodiments, a computer program may comprise instructions which, when executed on at least one processor, cause the at least one processor to carry out the method steps 501-504. A carrier may comprise the computer program, and the carrier is one of an electronic signal, optical signal, radio signal or computer readable storage medium.

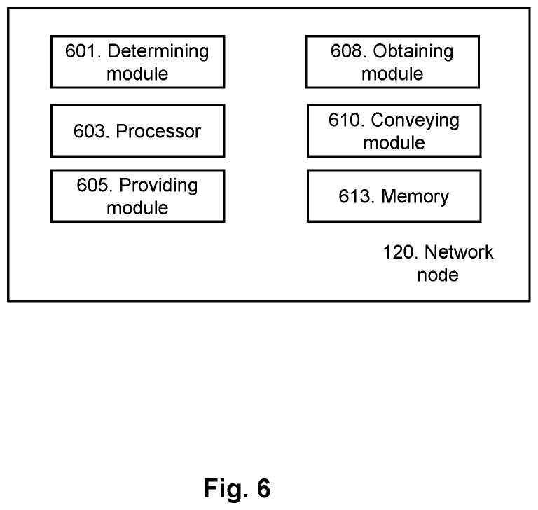

To perform the method steps shown in FIG. 3 for handling synchronization of sound the network node 120 may comprise an arrangement as shown in FIG. 6.

The network node 120 is adapted to, e.g. by means of a determining module 601, determine that speaker sound is currently outputted or will be outputted from at least one main speaker 100 located at a distance from a UE 108. The determined time delay may comprise a first time delay and a second time delay. The determining module 601 may also be referred to as a determining unit, a determining means, a determining circuit, means for determining etc. The determining module 601 may be a processor 603 of the network node 120 or comprised in the processor 603 of the network node 120.

The network node 120 is adapted to, e.g. by means of the determining module 601, determine a time delay between an output time for output of speaker sound from the at least one main speaker 100 and an arrival time for arrival of the speaker sound at the UE 108. The time delay is individually determined for the UE 108.

The network node 120 is adapted to, e.g. by means of a providing module 605, provide information indicating the determined time delay to the UE 108. The providing module 605 may also be referred to as a providing unit, a providing means, a providing circuit, means for providing etc. The providing module 605 may be the processor 603 of the network node 120 or comprised in the processor 603 of the network node 120. The providing module 605 may be referred to as a transmitting module.

The network node 120 may be adapted to, e.g. by means of the determining module 601, re-determine the time delay when it is detected that the distance between the at least one main speaker 100 and the UE 108 has changed compared to when a previous time delay was determined, e.g. the change distance may be detected by the network node 120.

The network node 120 may be adapted to, e.g. by means of the determining module 601, determine the time delay based on the distance between the UE 108 and the at least one main speaker 100.

The network node 120 may be adapted to, e.g. by means of an obtaining module 608, obtain information indicating a speaker position of the at least one main speaker 100 and a UE position of the UE 108. The obtaining module 608 may also be referred to as an obtaining unit, an obtaining means, an obtaining circuit, means for obtaining etc. The obtaining module 608 may be the processor 603 of the network node 120 or comprised in the processor 603 of the network node 120. The obtaining module 608 may be referred to as a receiving module.

The network node 120 may be adapted to, e.g. by means of a conveying module 610, convey speaker sound outputted over air from at least one main speaker 100 to the UE 108. The conveying module 610 may also be referred to as a conveying unit, a conveying means, a conveying circuit, means for conveying etc. The conveying module 610 may be the processor 603 of the network node 120 or comprised in the processor 603 of the network node 120. The conveying module 610 may be referred to as a transmitting module.

When a plurality of main speakers 100 are currently outputting or will be outputting the speaker sound, then the network node 120 is adapted to, e.g. by means of the determining module 601, determine time delay for each of the main speakers 100 in the plurality.

The network node 120 may be an access network node or a core network node.

The network node 120 may further comprise a memory 613 comprising one or more memory units. The memory 613 is arranged to be used to store data, received data streams, power level measurements, time delay, synchronized sound, distances, position, speaker sound, criterion information, threshold values, time periods, configurations, schedulings, and applications to perform the methods herein when being executed in the network node 613.

The present mechanism for handling synchronization of sound may be implemented through one or more processors, such as a processor 402 in the UE arrangement depicted in FIG. 4 and a processor 603 in the network node arrangement depicted in FIG. 6, together with computer program code for performing the functions of the embodiments herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the embodiments herein when being loaded into the UE 108 and/or the network node 120. One such carrier may be in the form of a CD ROM disc. It is however feasible with other data carriers such as a memory stick. The computer program code can furthermore be provided as pure program code on a server and downloaded to the UE 108 and/or the network node 120.

Summarized, the embodiments herein relate to a method performed by the UE 108, the UE 108, a network node 120 and a method performed by the network node 120. The network node 120 may distribute sound to ancillary speakers, i.e. the wearable UE speaker 110 associated with the UE 108. The wearable UE speaker 110 may be for example earplugs used by a user 105 at big arenas or outdoor events. The sound is to be time delayed and played in in the UE speaker 110 at the same time as sound from the at least one main speaker 100 arrive over air at the UE 108. The time delay may be calculated from the speaker position of the at least one main speaker 100 and the UE position of the UE 108, i.e. the position of the user 105 e.g. being a listener at the concert. The timed delay may also or instead be determined by using the UE's microphone to listen to sound from the main speaker 103 over air and determine the time delay by comparing the sounds.

The user 105 may turn up the volume to a wanted level when he is at e.g. an outdoor concert. It is possible to increase e.g. a higher frequency sound which may have been attenuated from a faraway at least one main speaker 100. The sound in the UE speaker 110 should match the sound from the at least one main speaker 100 in delay and pace.

The embodiments herein relate to an automatic ancillary speaker adjustment system.

The embodiments herein are not limited to the above described embodiments. Various alternatives, modifications and equivalents may be used. Therefore, the above embodiments should not be taken as limiting the scope of the embodiments, which is defined by the appended claims. A feature from one embodiment may be combined with one or more features of any other embodiment.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods defined in the appended claims may, without departing from the embodiments herein, be performed in another order than the order in which they appear in the claims.

1. A method performed by a user equipment (UE) for handling synchronization of sound, the method comprising:
determining that speaker sound is currently outputted or will be outputted from at least one main speaker located at a distance from the UE;
determining a time delay between an output time for output of speaker sound from the at least one main speaker and an arrival time for arrival of the speaker sound at the UE, wherein the time delay is individually determined for the UE; and
outputting synchronized sound comprising at least a part of the speaker sound with the time delay, wherein the synchronized sound is outputted by at least one wearable UE speaker comprised in the in synchrony with the speaker sound outputted by the at least one main speaker with respect to time delay and pace.

2. The method of claim 1, wherein the time delay is re-determined when it is detected that the distance between the at least one main speaker and the UE has changed compared to when a previous time delay was determined.

3. The method of claim 1, wherein
the time delay is determined based on the distance between the UE and the at least one main speaker,
the time delay is determined by obtaining information indicating the time delay from a user of the UE, and/or
the time delay is determined by receiving information indicating the time delay from a network node.

4-5. (canceled)

6. The method of claim 1, further comprising:
determining if the outputted synchronized sound fulfills a criterion;
when the criterion is not fulfilled, repeating the steps of determining the time delay and outputting the synchronized sound until the criterion is fulfilled; and
when the criterion is fulfilled, determining that only the step of outputting the synchronized sound should be repeated.

7. The method of claim 1, further comprising:
determining which parts of the speaker sound that should be comprised in the outputted synchronized sound; and/or
obtaining information indicating a position of the main speaker.

8. (canceled)

9. The method of claim 1, wherein the determined time delay comprises a first time delay and a second time delay, and
wherein the synchronized sound is outputted with the first time delay in a left ear part of the wearable UE speaker and with the second time delay in a right ear part of the wearable UE speaker.

10. The method of claim 1, wherein
the speaker sound is outputted over air from at least one main speaker via a network node before reaching the UE,
the wearable UE speaker is co-located with the UE or adapted to be connected to the UE, and/or
when a plurality of main speakers are currently outputting or will be outputting the speaker sound, then the time delay is determined for each of the main speakers in the plurality, and the synchronized sound comprises the speaker sound from each of the main speakers and their respective time delay.

11-12. (canceled)

13. A method performed by a network node for handling synchronization of sound, the method comprising:
determining that speaker sound is currently outputted or will be outputted from at least one main speaker located at a distance from a user equipment (UE);
determining a time delay between an output time for output of speaker sound from the at least one main speaker and an arrival time for arrival of the speaker sound at the UE, wherein the time delay is individually determined for the UE; and
providing information indicating the time delay to the UE.

14. The method of claim 13, wherein the time delay is re-determined when it is detected that the distance between the at least one main speaker and the UE has changed compared to when a previous time delay was determined.

15. The method of claim 13, wherein the time delay is determined based on the distance between the UE and the at least one main speaker.

16. The method of claim 13, further comprising:
obtaining information indicating a speaker position of the main speaker and a UE position of the UE.

17. The method of claim 13, wherein the time delay comprises a first time delay and a second time delay.

18. The method of claim 13, wherein
the network node conveys speaker sound outputted over air from at least one main speaker to the UE,
when a plurality of main speakers are currently outputting or will be outputting the speaker sound, then the time delay is determined for each of the main speakers in the plurality, and/or
the network node is an access network node or a core network node.

19-20. (canceled)

21. A user equipment (UE) adapted for handling synchronization of sound, the UE being configured to:
determine that speaker sound is currently outputted or will be outputted from at least one main speaker located at a distance from the UE;
determine a time delay between an output time for output of speaker sound from the at least one main speaker and an arrival time for arrival of the speaker sound at the UE, wherein the time delay is individually determined for the UE; and to
output synchronized sound comprising at least a part of the speaker sound with the time delay, wherein the synchronized sound is outputted by at least one wearable UE speaker comprised in the UE in synchrony with the speaker sound outputted by the at least one main speaker with respect to time delay and pace.

22. The UE according to of claim 21, wherein UE is further configured to re-determined the time delay as a result of the UE detecting that the distance between the at least one main speaker and the UE has changed compared to when a previous time delay was determined.

23-32. (canceled)

33. A network node adapted for handling synchronization of sound, the network node being adapted configured to:
determine that speaker sound is currently outputted or will be outputted from at least one main speaker located at a distance from a user equipment (UE);
determine a time delay between an output time for output of speaker sound from the at least one main speaker and an arrival time for arrival of the speaker sound at the UE, wherein the time delay is individually determined for the UE; and
provide information indicating the time delay to the UE.

34. The network node of claim 33, wherein the network node is configured to re-determine the time delay as a result of detecting that the distance between the at least one main speaker and the UE has changed compared to when a previous time delay was determined.

35-44. (canceled)
